(19) United States
(12) Patent Application Publication
(10) Pub. No.: US 2007/0266396 A1
(43) Pub. Date: Nov. 15, 2007

(54) System and Method for Implementing Location-Based Content Restrictions in a Mobile Video Broadcast Environment

(75) Inventor: Erik J. Estermann, Carlsbad, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: GENERAL INSTRUMENT CORPORATION, Horsham, PA (US)

(21) Appl. No.: 11/747,682

(22) Filed: May 11, 2007

Related U.S. Application Data
(60) Provisional application No. 60/799,603, filed on May 11, 2006.

(51) Int. Cl. H04N 7/16; H04N 7/167; H04B 1/06

(52) U.S. Cl. 725/25; 725/31; 455/26.1; 380/239

(57) ABSTRACT

A system and method for implementing location-based content restrictions in a mobile video broadcast is provided. The invention utilizes DVB-H KSMs to transmit the restrictions and thereby enables the restrictions to be enforced by the mobile terminal receiving a broadcast video signal. This need for enforcement is determined as a function of the received KSMs and the physical location of the receiving terminal (as sensed using one or more accepted navigation technologies (e.g., Global Positioning System (“GPS”) technology, Assisted GPS (“AGPS”) technology, etc.).

### CROSS-REFERENCE TO RELATED APPLICATION

This application claims priority to the filing date of a U.S. provisional patent application having Ser. No. 60/799,603, entitled “LOCATION-BASED CONTENT RESTRICTIONS IN MOBILE BROADCAST APPLICATIONS”, filed on May 11, 2006, which is incorporated herein by reference in its entirety.

### FIELD OF THE INVENTION

This invention relates to the field of video broadcasting, and in particular to video broadcasting implemented in accordance with the Digital Video Broadcasting-Handheld (“DVB-H”) specification (ETSI standard EN 302 304).

### BACKGROUND OF THE INVENTION

DVB-H was developed as a technology standard for the transmission of digital TV to handheld terminals such as mobile telephones and PDAs. Published as a formal standard (EN 203 204) by ETSI in November 2004. DVB-H specifies a physical layer designed to enable the efficient delivery of Internet Protocol (“IP”) encapsulated data over terrestrial networks. In particular, IP data delivery over DVB-H is an end-to-end broadcast system for delivery of digital content and services using IP-based mechanisms optimized for devices with limitations on computational resources and battery. An inherent part of the IP Datacast system is that it comprises a unidirectional DVB broadcast path that may be combined with a bidirectional mobile/cellular interactivity path.

The protocols and specifications for content/service access within IP DVB-H systems and networks are detailed in “IP Datacast over DVB-H: Service Purchase and Protection (SPP)”, DVB Document A100, December 2005 (“A100”). As described in A100, DVB-H provides for a Key Stream Layer (“KSL”) to implement the delivery of Traffic Encryption Keys (“TEKs”) via the transmission of Key Stream Messages (“KSMs”) to receiving terminals on a broadcast channel. These KSMs contain information that enables the receiving terminals to reconstruct TEKs needed to decrypt and access the content being delivered via the broadcast signal. At present, the DVB-H specification operates under an Open Security Framework that allows service providers to employ KSMs that define both key stream and content rights management.

DVB-H video transmissions can be broadcast utilizing both multi-frequency and single frequency transmitters to provide coverage for a given terrestrial region. The DVB-H specification provides for an Electronic Service Guide (“ESG”) that permits terminal users to select services, programs or items of interest from a listing of broadcast and stored content. This ESG is specified in “IP Datacast over DVB-H: Electronic Service Guide (ESG)”, DVB Document A099, November 2005 (“A099”). Users of DVB-H compatible terminals in the coverage region would receive and render the broadcast signals for viewing or storage. Typically, a DVB-H broadcast from a given transmitter to a surrounding region would deliver identical content to all DVB-H compatible terminals in that broadcast region. However, it can be desirable for broadcaster to limit the rendering of certain broadcasted content to specific DVB-H terminals based upon the location of those terminals within the broadcast region.

For example, if a particular broadcasted sporting event needs to be “blacked-out” in a particular town within the broadcast region due to contractual obligations to a content owner, a broadcaster of that event might not want the liability of such content being viewed upon a handheld terminal receiver when that terminal is carried into a blacked-out town. In this scenario it would not be desirable to remove the sporting event content from the broadcast signal as it can rightfully be viewed on DVB-H terminals within the broadcast region that are not in the blacked-out town.

It would be advantageous, therefore, to provide DVB-H video broadcasting functionality permitting a content provider to selectively restrict content from being rendered on mobile terminals as a function of the location of those terminals..

### SUMMARY OF THE INVENTION

In accordance with the principles of this invention an improved system and method for implementing location-based content restrictions in a mobile video broadcast is provided. The invention utilizes DVB-H KSMs to transmit the restrictions and thereby enables the restrictions to be enforced by the mobile terminal receiving a broadcast video signal. This need for enforcement is determined as a function of the received KSMs and the physical location of the receiving terminal (as sensed using one or more accepted navigation technologies (e.g., Global Positioning System (“GPS”) technology, Assisted GPS (“AGPS”) technology, etc.).

### BRIEF DESCRIPTION OF THE DRAWINGS

For a complete understanding of the present invention and the advantages thereof, reference is now made to the following description taken in conjunction with the accompanying drawings, wherein:

FIG. 1 is a diagram depicting a normal location-based restriction imposed upon a mobile communication broadcast region in accordance with a preferred embodiment of the invention;

FIG. 2 is a block diagram a particular Electronic Service Guide (“ESG”) use case supporting location-based content restrictions in accordance with a preferred embodiment of the invention;

FIG. 3 is a diagram depicting a normal location-based restriction imposed upon a mobile communication broadcast region utilizing a defined polygon in accordance with a preferred embodiment of the invention;

FIG. 4 is a diagram depicting an inverse location-based restriction imposed upon a mobile communication broadcast region utilizing a defined ellipse in accordance with a preferred embodiment of the invention; and

FIG. 5 is a diagram depicting an override of a location-based restriction imposed upon a mobile communication broadcast region in accordance with a preferred embodiment of the invention.

### DESCRIPTION OF PREFERRED EMBODIMENTS

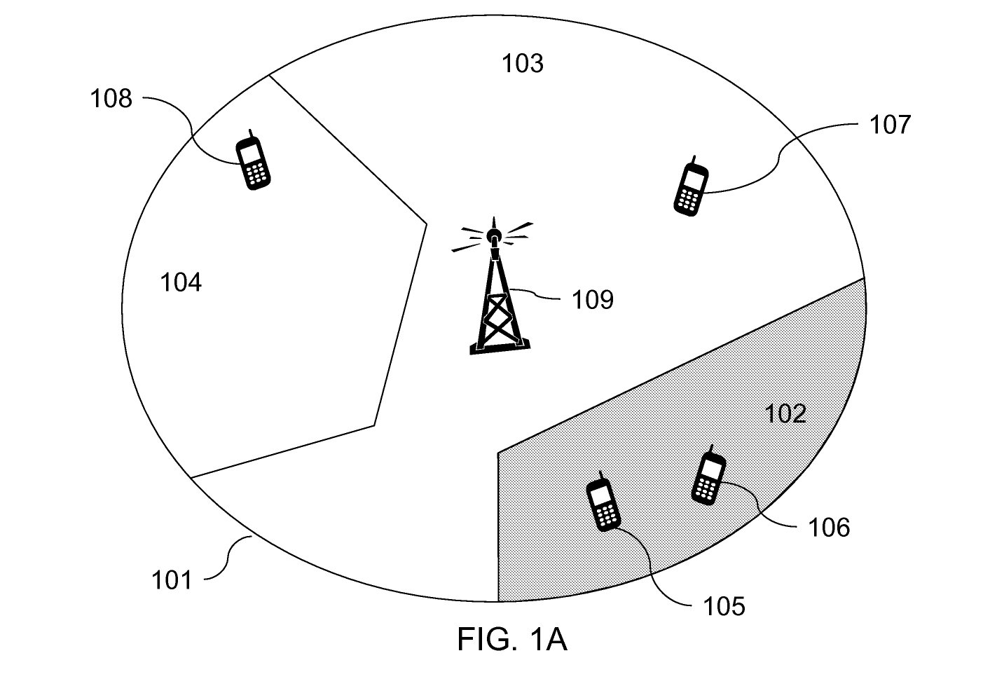

Referring to FIG. 1, a normal location-based restriction mapping of a video broadcast region 101 is depicted and, as shown, this broadcast region covers three distinct zones (102, 103 and 104). Each of these zones corresponds to a particular geographic area within broadcast region 101, which could, for example, be three distinct neighborhoods, towns, states, countries, or other areas defined by arbitrary borders. The signal being transmitted from transmitter 109 radiates throughout broadcast region 101. However, it is desired that the particular content carried by the transmitted signal be rendered only by terminals located in zones 103 and 104, and that terminals within zone 102 be prohibited from rendering that content (zone 102 is blacked-out, as indicated by the shading in the FIG. 1). The need to black-out a particular reception zone may arise from any arbitrary regulatory or commercial limitation, such as a contractual obligation to the content owner. For purposes of this description, it shall be assumed that these terminals are DVB-H compatible terminals conforming to the Global System for Mobile Communications/3rd Generation Partnership Project (“GSM/3GPP”) standard, although other types of DVB-H terminals could also be adapted to operate according to the principles of this invention.

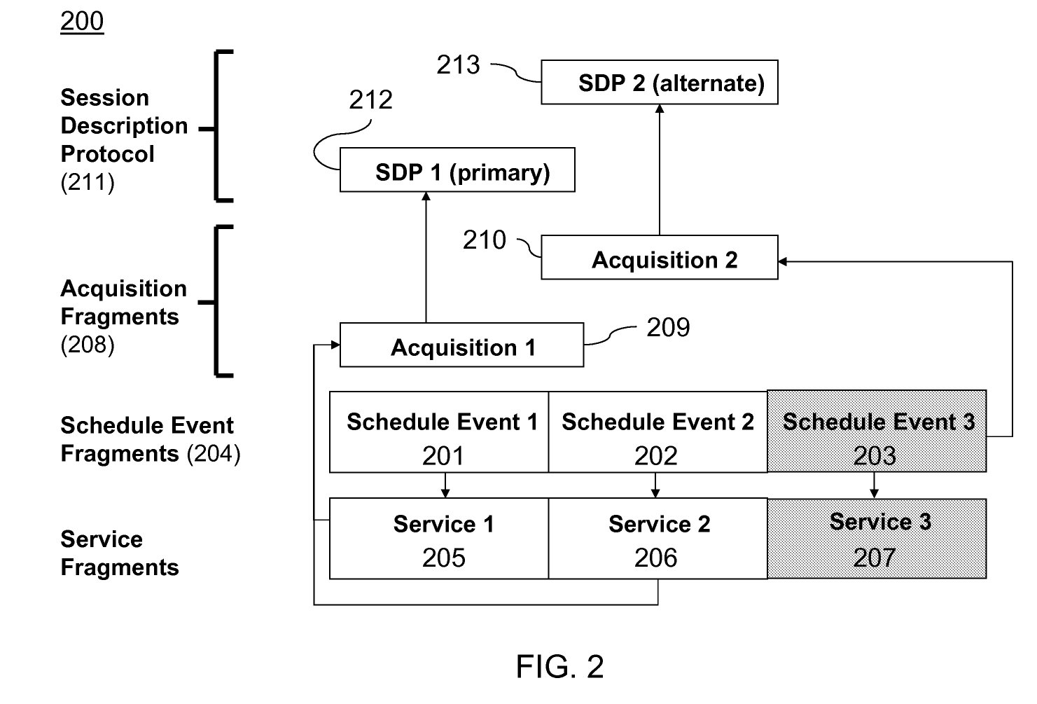

The ability to selectively restrict rendering is supported within the DVB-H specification, and illustrated by the ESG use case 200 shown in FIG. 2. In accordance with the illustrated scenario, the broadcast of three content offerings (Schedule Events 1 (201), 2 (202) and 3 (203)) are shown to be communicated to a terminal via Schedule Event Fragments (204). In accordance with A099, the Schedule Event Fragments would provide the terminal with the specific broadcast time for the Schedule Events 1, 2 and 3. Each of the Schedule Events has an associated Service Fragment (205, 206, 207), each of which, in accordance with A099, specifies service type (TV, related material, etc.), certain content restrictions for the Schedule Event (parental guidance, private data, etc), and specifies an Acquisition Type referencing a particular Acquisition Fragment (208). Acquisition Fragments specify information required for a terminal to access DVB-H services and content (A099). As shown in FIG. 2, Schedule Events 1 and 2 are associated with Acquisition Fragment 1 (209), while Schedule Event 3 is associated with Acquisition Type 2 (210). Finally, each of the Acquisition Fragments reference Session Description Protocols (“SDPs”) (211), each of which contain information needed by the terminal to render the associated content. Acquisition Fragment 1 references SDP 1 (212), which is a primary SDP permitting the rendering of Schedule Events 1 and 2. Contrastingly, Acquisition Fragment 2 references SDP 2 (213), which is an alternate SDP representing an alternate program if the terminal is blacked-out during Schedule Event 3. It is this type of operation that the present invention facilitates as a function of location.

As previously stated, DVB-H allows service providers to employ KSMs that define both key stream and content rights management. In a preferred embodiment of this invention, a KSM format which introduces an access criteria descriptor value “location_based restriction_descriptor”. The syntax associated with this descriptor is as shown in Table 1:

TABLE 1

| location_based_restriction_descriptor | Length | Type |
|---|---|---|
| Interpretation | 1 | uimsbf |
| Override | 1 | uimsbf |
| reserved_for_future_use | 6 | bslbf |
| type_of_shape | 4 | uimsbf |
| if ( type_of_shape = ‘ 0001’ ) ( | | bslbf |
| reserved_for_future_use | 4 | bslbf |
| Latitude | 24 | bslbf |
| Longitude | 24 | bslbf |
| reserved_for_future_use | 1 | bslbf |
| uncertainty_code | 7 | uimsbf |
| ) | | |
| if ( type_of_shape == ‘ 0101’ ) ( | | |
| number_of_points | 4 | bslbf |
| for ( i=0; l < number_of_points; i++ ) ( | | |
| Latitude | 24 | bslbf |
| Longitude | 24 | bslbf |
| } | | |
| } | | |

### This syntax is compliant with A099.

The particular flags and values upon which this descriptor operates are as follows:

interpretation—A flag specifying how the restriction is to be interpreted by the terminal. If this flag is set to 0 (“normal”), a terminal residing in the defined area may not render the associated content in the broadcast stream. If this flag is set to 1 (“spotbeam”), a terminal residing in the defined area may render the associated content in the broadcast stream.

override—A flag specifying whether the location-based restriction may be ignored by a properly authorized terminal. If set to 0, the restriction must be obeyed and the terminal may not render the associated content in the broadcast stream. If set to “1”, the terminal my ignore the restriction, and render the associated content. This permits a service provider to selectively permit certain terminals to render otherwise restricted content regardless of the terminal's physical location. A service provider might also use this feature to permit an unauthorized terminal to render a notification regarding the ability to purchase rights to presently restricted content.

type_of_shape—A four bit value specifying the type of shape conveyed by the descriptor in accordance with Section 7.2 of 3GPP/GSM Technical Specification Group Core Network Universal Geographical Area Description, Release 6 (“GAD”)—A location description specification that utilizes GPS as its reference system. While GAD supports the definition of numerous shapes defined about one or more geographic points, for this example only an ellipsoid point with an uncertainty circle (associated with binary designator “0001” in Table 1) and a polygon (associated with binary designator “0001” in Table 1). The ellipsoid is defined about a single point, the polygon can be defined with between 3 and 15 points.

latitude—A 24-bit value representing the coordinate latitude of a point on an ellipsoid per Sections 6.1 and 7.3.2 of GAD.

longitude—A 24-bit value representing the coordinate longitude of a point on an ellipsoid per Section 6.1 and 7.3.2 of GAD.

uncertainty_code—A 7-bit value, K, representing the radius about an ellipsoid point per sections 6.2 and 7.3.2 of GAD.

number_of_points—A 4-bit value representing the number of points of a polygon which circumscribes a defined geographical area. The number of points must be at least three, and no greater than 15, per GAD.

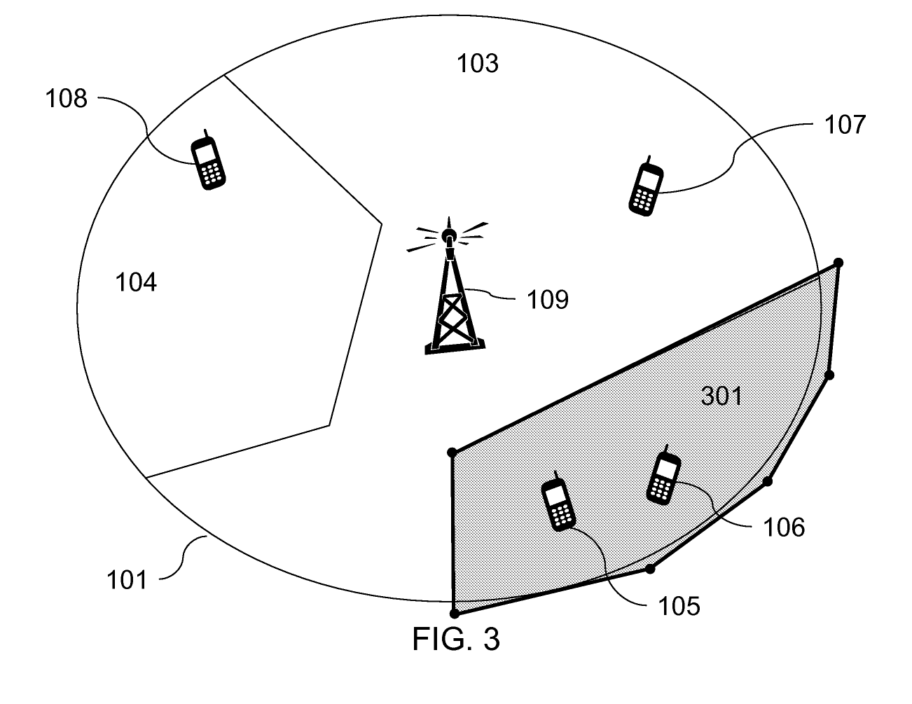

As shown in FIG. 3, employing the ESG, KSM and location-based descriptor syntax detailed above a DVB-H service provider could specify a geographic region defined by a polygon 301 with as little as five or six points that would accurately approximate black-out zone 102 depicted in FIG. 1. Terminals that have a position falling within polygon 301, and not having an override flag of “1”, would be unable to render the content associated with the geographically-limited Acquisition Fragment/SDP. They may instead be able to render programming associated with the alternate SDP.

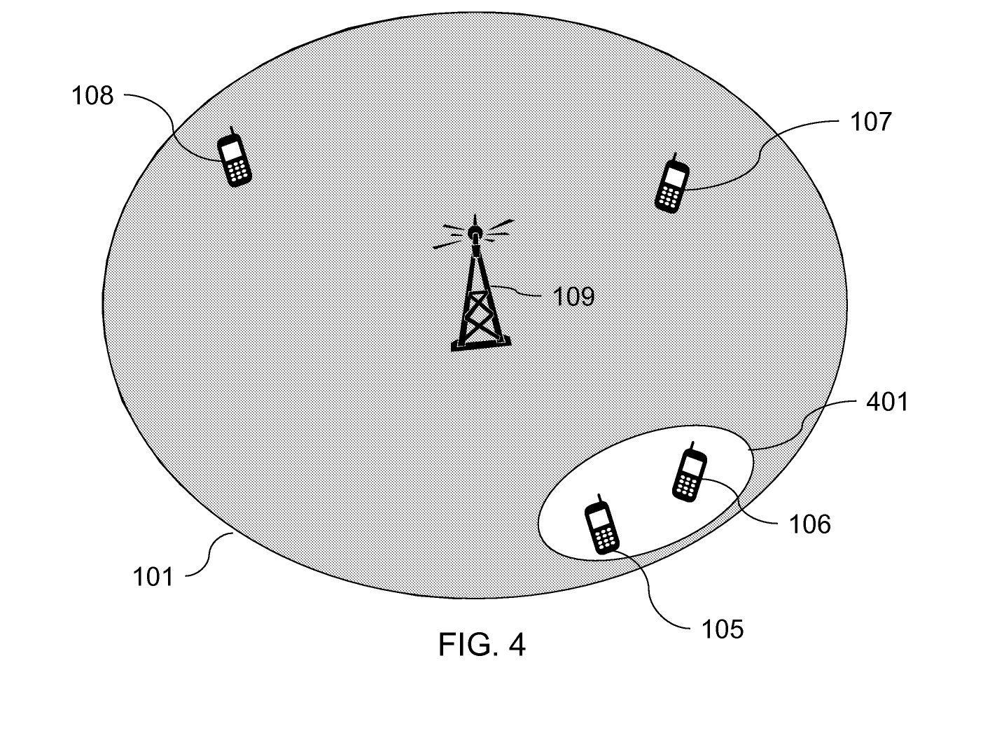

Of course, a service provider could choose to blackout the vast majority of the broadcast region from rendering particular content, inverting the rendering distribution so that the majority of locations within a video broadcast region are blacked-out. Such an inverse location-based inversion is depicted in FIG. 4. This figure depicts an inverse location-based restriction mapping where the only region not blacked-out is the limited area defined by ellipse 401. Only terminals 105 and 106 would be permitted to render the subject content.

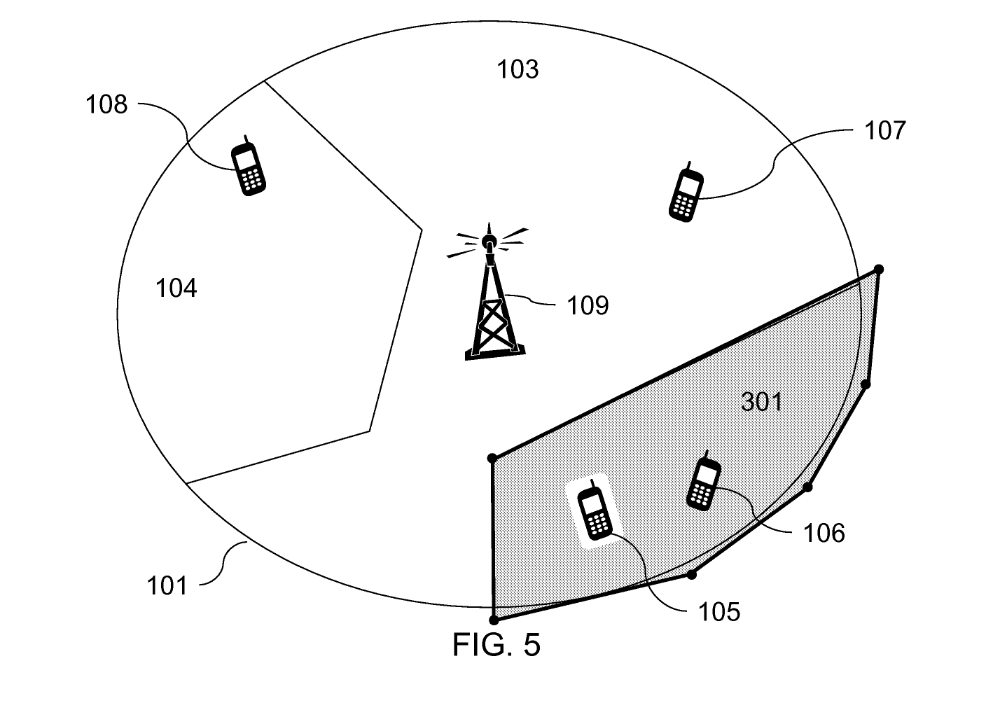

Finally, FIG. 5 depicts a case wherein the service provider has defined a polygon where content will be blacked-out, similar to that of FIG. 3. However, in this case all terminals receive an override flag of “1”. Terminal 105 has been previously authorized to override blackouts if the override flag is set, and therefore it need not obey the geographic restrictions imposed upon other terminals in the black-out region (such as terminal 106). Terminal 105 may render the otherwise restricted content.

Although the invention has been described herein by reference to exemplary embodiments thereof, it will be understood that modification and variation to such, without departing from the inventive concepts disclosed, can be made. All such modifications and variations, therefore, are intended to be encompassed within the spirit and scope of the appended claims.

I claim:

1. A terminal-based system for enforcing location-based content restrictions in a mobile video broadcast comprising:
an antenna adapted for receiving at least one broadcast DVB-H compliant digital video transmission within a broadcasting region;
a terrestrial location sensor adapted to determine the terminal's physical location using one or more terrestrial navigation technologies;
a key stream layer implementing a location-contingent content rendering syntax whereby the terminal gains access to DVB-H content associated with the syntax unless the terminal is located within a blacked-out geographic location within the broadcast region.

2. The terminal-based system of claim 1 wherein the one or more terrestrial navigation technologies includes GPS.

3. The terminal-based system of claim 1 wherein the one or more terrestrial navigation technologies includes AGPS.

4. The terminal-based system of claim 1 wherein the blacked-out geographic location is defined by an ellipse.

5. The terminal-based system of claim 1 wherein the blacked-out geographic location is defined by a polygon.

6. The terminal-based system of claim 1 further comprising an override syntax which when received by a terminal enables access to DVB-H content associated with the syntax regardless of the terminal being located within a blacked-out geographic location.

7. A method for implementing a terminal-based system for the enforcement of location-based content restrictions in a mobile video broadcast comprising the steps of:
receiving at a terminal least one broadcast DVB-H compliant digital video transmission within a broadcasting region;
sensing the terminal's physical location using one or more terrestrial navigation technologies;
implementing a key stream layer dependent ESG whereby the terminal gains access to DVB-H content associated with the key stream layer unless the terminal is located within a blacked-out geographic location within the broadcast region.

8. The method of claim 7 wherein the one or more terrestrial navigation technologies includes GPS.

9. The method of claim 7 wherein the one or more terrestrial navigation technologies includes AGPS.

10. The method of claim 7 wherein the blacked-out geographic location is defined by an ellipse.

11. The method of claim 7 wherein the blacked-out geographic location is defined by a polygon.

12. The method of claim 7 further comprising the step of:
responding to an a override syntax and thereby enabling access to DVB-H content associated with the syntax regardless of the terminal being located within a blacked-out geographic location.
